(19) United States
(12) Patent Application Publication
(10) Pub. No.: US 2007/0043947 A1
(43) Pub. Date: Feb. 22, 2007

(54) Providing multimedia system security to removable user identity modules

(76) Inventors: Semyon B. Mizikovsky, Morganville, NJ (US); Zhibi Wang, Woodridge, IL (US)

Correspondence Address: WILLIAMS, MORGAN & AMERSON, 10333 RICHMOND, SUITE 1100, HOUSTON, TX, 77042, US

(21) Appl. No.: 11/208,137

(22) Filed: Aug. 19, 2005

(51) Int. Cl. H04L 9/32; H04L 9/00; G06F 15/16; G06F 17/30; G06F 7/04; G06F 7/58; G06K 19/00; G06K 9/00

(52) U.S. Cl. 713/172; 713/181; 713/176; 726/3; 726/9

(57) ABSTRACT

The present invention provides a method of authenticating a user identity module to an entry node of a wireless communication system. The method may include receiving a first challenge formed according to a first security protocol from the entry node and forming, according to a second security protocol different from the first security protocol, a second challenge based on the first challenge. The method may also include providing the second challenge to the user identity module.

### BACKGROUND OF THE INVENTION

1. Field of the Invention

This invention relates generally to communication systems, and, more particularly, to wireless communication systems.

2. Description of the Related Art

Security for cellular networks has evolved rapidly in recent years, in large part due to the increasing customer demand for wireless services, such as voice communication, data communication, and multimedia services like video telephony. Cryptographic digital authentication may be implemented in digital communication systems, such as Second Generation (2G) wireless communication systems, to protect service providers from the fraudulent use of their networks and to provide user privacy. For example, the Telecommunication Industry Association (TIA), the Electronics Industry Association (EIA), and others developed a 64-bit security scheme called ANSI TIA/EIA-41. The TIA/EIA-41 security scheme provides mutual authentication between a home authentication center (e.g., a Home Location Register/Authentication Center, HLR/AuC) and a user identity module (UIM), such as a removable identity module (R-UIM), which is typically a card that can be inserted into a mobile shell, or an integrated UIM.

In the TIA/EIA-41 security scheme, a private key, such as a 64-bit random secret known as the A-KEY, is pre-provisioned to a well-protected database in the HLR/AuC and the R-UIM. The private key may be used to secure the wireless link between the HLR/AuC and the R-UIM. For example, the private key may be used to generate a temporary secondary key (known as the shared secret data, SSD, key). The system may then initiate a global challenge authentication by providing a random number (RAND) to the R-UIM, which computes a short digital signature:
AUTHR=f(RAND,SSD_{—}A,ESN,AUTH_DATA),
where f( ) is a standardized function called CAVE, SSD_A is a selected portion of the SSD key, ESN is the electronic serial number associated with the R-UIM, and AUTH_DATA is populated based on the mobile unit's mobile identification number (MIN). The R-UIM provides the AUTHR digital signature to the system (e.g., the HLR/AuC), which may validate the R-UIM based on the AUTHR digital signature. The R-UIM and the HLR/AuC may also compute additional keys, such as a 64-bit signaling message key (SMEKEY) and a 520-bit voice privacy mask (VPM), which may be used as a seed to generate a private long code mask (PLCM), as opposed to the public long code mask that may be generated from the publicly known electronic serial number (ESN) of the mobile.

Second generation wireless communication systems and networks are being replaced by wireless communication systems and networks that operate in accordance with third generation (3G) wireless communication standards, such as the wireless communication standards for UMTS defined by the Third Generation Partnership Project (3GPP) and the wireless communication standards for CDMA defined by the Third Generation Partnership Project-2 (3GPP2). For example, the 3GPP 33.203 and the 3GPP2 S.R0086 specifications define an Internet Protocol (IP) Multimedia Subsystem (IMS) that defines standards for using a signalling protocol called the Session Initiation Protocol (SIP). The SIP may be used to support various multimedia services that are provided to a mobile unit over an air interface. Exemplary IMS services include Internet conferencing, Internet telephony, video telephony, event notification, instant messaging, and the like.

Third generation wireless communication standards require use of the mutually authenticated Authentication and Key Agreement (AKA) security protocol. For example, the 3GPP 33.203 and the 3GPP2 S.R0086 standards define an IMS security protocol that uses the AKA security protocol to establish a security association between an IP Multimedia User Entity (UE) and the first entry node of the IMS network, e.g., a Proxy Call Session Control Function (P-CSCF). The network and the UE may then be mutually authenticated using information stored in and/or derived by a Home Subscriber Server (HSS), an Authentication, Authorization, and Accounting server (AAA), and/or a Server Call Session Control Function (S-CSCF).

Customers using second generation R-UIM cards may want to access some or all of the additional services provided by the third generation technology. For example, the customer may buy a mobile unit that supports multimedia services that are provided according to the IMS protocol. However, the second generation R-UIM cards do not support the AKA security protocol and third generation networks are not able to mutually authenticate the second generation R-UIM cards. Consequently, the customer will not be able to utilize the services defined by the IMS protocol, even though the mobile unit containing the second generation R-UIM card may support IMS functionality. Customers may also be reluctant to discard their R-UIM cards and replace them with 3G-compatible cards, which may slow adoption and implementation of multimedia services allowed by the third generation technologies.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for authenticating at least one user identity module and an entry node of a wireless communication system. The method may include receiving at least a first challenge formed according to at least a first security protocol from the entry node and forming, according to at least one second security protocol different from the first security protocol, at least one second challenge based on the first challenge. The method may also include providing the second challenge to the user identity module.

In another embodiment of the present invention, a method is provided for authenticating at least one user identity module associated with at least one mobile unit. The method may include providing at least one first challenge formed according to at least one first security protocol to the mobile unit and receiving at least one first response formed based on at least one second response provided to the mobile unit by the user identity module. The second response may be formed based on the first challenge according to at least one second security protocol different from the first security protocol. The method may also include authenticating the user identity module based on the first response.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communications system, in accordance with the present invention;

FIG. 2 conceptually illustrates a first portion of one exemplary embodiment of a method of mutually authenticating a user identity module (UIM) and a first entry node, in accordance with the present invention; and

FIG. 3 conceptually illustrates a second portion of one exemplary embodiment of a method of mutually authenticating a user identity module (UIM) and a first entry node, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

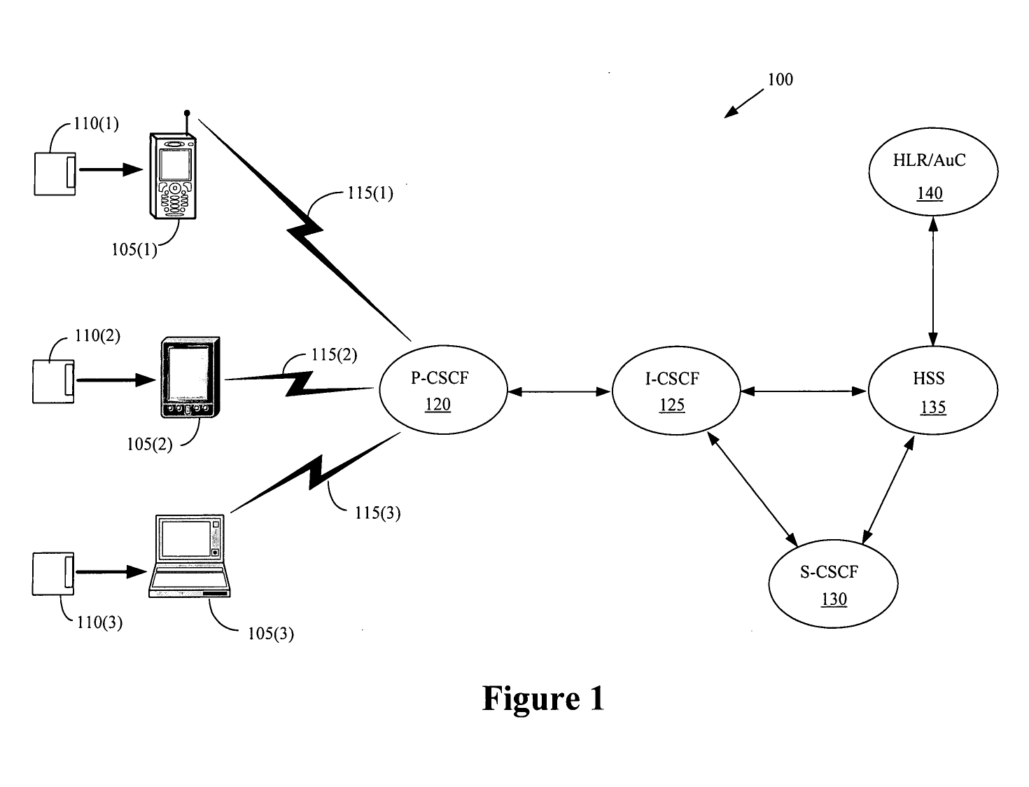

FIG. 1 conceptually illustrates one exemplary embodiment of a wireless communications system 100. In the illustrated embodiment, the wireless communications system 100 may provide wireless connectivity according to a third generation wireless communication protocol such as the Code Division Multiple Access (CDMA) protocol defined in ANSI TIA/EIA/IS-2000 standard. However, persons of ordinary skill in the art should appreciate that the present invention is not limited to a wireless communications system 100 that operates according to the CDMA protocol. In alternative embodiment, any wireless communication protocol may be used to provide wireless connectivity. Furthermore, in some embodiments, the wireless communications system 100 may include, or be connected to, one or more wired communication systems.

The wireless communications system 100 shown in FIG. 1 may provide wireless connectivity to one or more mobile units 105(1-3). In the interest of clarity, the indices (1-3) will hereinafter be dropped when the mobile units 105 are being referred to collectively. However, the indices (1-3) may be used when referring to the mobile units 105 individually or to a subset of the mobile units 105. The same convention will be used with regard to other indices that distinguish between components that share an identifying numeral. The mobile units 105 may be any type of mobile unit including, but not limited to, a cellular telephone 105(1), a personal data assistant 105(2), and a laptop computer 105(3). However, persons of ordinary skill in the art having benefit of the present disclosure should appreciate that the present invention is not limited to these particular examples of mobile units 105 and in alternative embodiments other types of mobile units 105 may also be used. Persons of ordinary skill in the art should also appreciate that the mobile units 105 may be referred to using other terms such as mobile shell, user equipment, user terminal, access terminal, and the like.

A user may provide a user identity module 110(1-3) that includes information indicative of the user, as well as information that may be used to verify the user's identity to the wireless communications system 100. In the illustrated embodiment, the user identity modules 110 are removable user identity modules (R-UIMs) 110 that operate according to second-generation wireless telecommunications standards such as the TIA/EIA-41 standard and ANSI TIA/EIA/IS-2000 standard. The user identity modules 110 may include one or more keys that are used to establish a security association with the wireless communications system 100. For example, the user identity modules 110 may each include a pre-provisioned 64-bit random number known as an A-KEY. Accordingly, the user identity modules 110 may support the 2G authentication contents specified in ANSI TIA/EIA/IS-2000 and ANSI TIA/EIA-41, consisting of the A-KEY, derivatives of the A-KEY such as SSD-A and SSD-B, the cryptographic function CAVE, and the ability to process 2G authentication requests like Global Challenge, Unique Challenge, and generation of session keys, such as the SMEKEY and the Private Long Code Mask (PLCM).

The mobile units 105 may establish one or more wireless communication links with the wireless communications system 100 over air interfaces 115(1-3). The air interfaces 115 may connect the mobile units 105 to a first entry node 120 of the wireless communications system 100. In the illustrated embodiment, the first entry node is a proxy call session control function (P-CSCF) 120, which is communicatively coupled to an interrogator CSCF (I-CSCF) 125. The I-CSCF 125 may be communicatively coupled to a server CSCF (S-CSCF) 130 and a Home Subscription Server (HSS) 135, which may be communicatively coupled to a Home Location Register (HLR) and/or an Authentication Center (AuC) 140. The P-CSCF 120, I-CSCF 125, S-CSCF 130, HSS 135, and HLR/AuC 140 are known in the art and in the interest of clarity only those aspects of the operation of these elements that are relevant to the present invention will be described further herein. Furthermore, persons of ordinary skill in the art having benefit of the present disclosure should appreciate that, in alternative embodiments, the first entry node 120 may be coupled more, fewer, and/or different elements of the wireless communication network 100.

The wireless communication network 100 provides one or more security protocols that may be used to mutually authenticate the wireless communication network 100 and devices that are communicatively coupled to the wireless communication network 100. In the illustrated embodiment, the P-CSCF 120 authenticates user equipment to the wireless communication network 100. For example, the P-CSCF 120 may provide mutual authentication using the Authentication and Key Agreement (AKA) security protocols. In one embodiment, the P-CSCF 120 provides Internet Protocol Multimedia Subsystem (IMS) security as defined by the 3GPP 33.203 standard and the 3GPP2 S.R0086 standard, which specify how the SIP signaling between user equipment and the first entry node is protected.

However, the security protocols used by the user identity modules 110 may be different than the security protocols implemented by the wireless communications system 100 and, in particular, the P-CSCF 120. Accordingly, the mobile units 105 may be capable of translating authentication information received from the wireless communications system 100 into a form of that the user identity modules 110 may use to authenticate the wireless communications system 100. The mobile units 105 may also be capable of translating authentication information received from the user identity modules 110 into a form that the wireless communications system 100 may use to authenticate the user identity modules 110. In one embodiment, the mobile unit 105 may translate authentication interrogation contents received in IP-based SIP signaling from the P-CSCF 120 into 2G authentication requests that may be provided to the user identity modules 110. The mobile unit 105 may also repackage responses received from the user identity modules 110 into SIP signaling and deliver it to the IMS network via the P-CSCF 120. The mobile unit 105 may also use session keys received from the user identity module 110 to generate additional session keys for IMS security.

The HSS 135 may access security information associated with the user identity modules 110 and use this information for authenticating the user identity modules 110 to the wireless communication system 100. In one embodiment, the HSS 135 accesses security information associated with the user identity modules 110 stored in the HLR 140. For example, the HSS 135 may implement an SS7-based IS-41 interface with support for one IS-41 transaction, such as an Authentication Request (AUTHREQ) transaction, which may be communicated to the HLR/AuC 140. The HLR/AuC 140 may view the HSS 135 as an IS-41 Visitor Location Register (VLR). Alternatively, an SS7-to-IP translator function may be implemented to make the HLR/AuC 140 look like an IP-based RADIUS host to the HSS 135, while the HSS 135 may look like a IS-41 VLR to the HLR/AuC 140. The HSS 135 may also use session keys received from the HLR/AuC 140 to generate session keys according to the IMS security protocols.

In one embodiment, an IMS identity of a user may be bound to an identity of a subscription to prevent an attacker from subscribing to a general CDMA service and using a victim's IMS Identity for SIP Registration, so that the victim's subscription could be billed for IMS services. For example, a user's IP Multimedia Private Identity (IMPI) and IP Multimedia Public Identity (IMPU) may be bound to the user's IP Mobile Subscriber Identity (IMSI). Mobile units 105 may therefore build the IMPI and IMPU from the IMSI as described in 3GPP TS 23.003 sec.13.3 and 13.4. The mobile unit 105 may only communicate the IMPI and IMPU to the S-CSCF 130 and HSS 135. The HSS 135 may derive the IMSI from the IMPI and IMPU. This derived IMSI may be included in the IS-41 AUTHREQ and validated by the HLR/AuC 140. If address substitution were attempted, the validation of AUTHR would fail.

The wireless communication system 100 may, in some embodiments, provide authentication challenges in the form of HTTP digests, as will be described in detail below. The mobile unit 110 may then provide an HTTP digest response that is generated using a key, such as the SMEKEY, as a password. This approach may help prevent an attacker from performing an address substitution attack by using the value of RAND received from the wireless communication system 100, sending a paging message to the victim's mobile unit 110, and receiving the needed AUTHR in a page response from the mobile unit 110. The attacker would be prevented from collecting all information needed to continue IMS access on behalf of the victim because the attacker would not have the derivative from the Global Challenge Authentication, like the SMEKEY password, because this information is not transmitted over the air.

The mobile units 105 may therefore, in some embodiments, be configured to create the IMPI and IMPU from the IMSI according to 3GPP TS 23.003, or similar procedure. The mobile units 105 may issue the CDMA2000 Global Challenge Authentication Request to the user identity modules 110 using the 32 LSB of HTTP Digest CHALLENGE as the Global RAND. The mobile units 105 may set the HTTP Digest, or “cnonce,” value to AUTHR padded with 6 zeros to the closest octet boundary (24 bits) and use the SMEKEY received from the user identity modules 110 as an HTTP Digest Password to compute the HTTP Digest RESPONSE by using an MD5 or SHA-1 algorithm defined for the HTTP Digest protocol. In one embodiment, the mobile unit 105 may compute a cipher key (CK) and/or an integrity key (IK) from the SMEKEY and PLCM received from the user identity modules 110. These cipher and integrity keys may further be used to protect subsequent SIP signaling between a mobile unit and P-CSCF.

The wireless communication system 100 may also support the HTTP digest functionality. In one embodiment, the S-CSCF 135 may populate the SIP-Auth-Data-Item AVP of the Multimedia-Auth-Request (MAR) command on a Cx:Diameter interface with the concatenated value of 32 Least Significant Bits of HTTP Digest, or “nonce,” and the value of the HTTP Digest “cnonce,” which represents the R-UIM authentication response AUTHR defined above. The HSS 135 may be able to derive the IMSI from IMPI and IMPU according to 3GPP TS 33.003, or similar procedure. The HSS 135 may also be able to decompose the SIP-Auth-Data-Item AVP by using the 32 MSB as the RAND and using the 18 MSB of the remaining 24 bits as the AUTHR. The HSS 135 may issue an SS7 IS-41 Authentication Request AUTHREQ to the HLR/AuC 140 associated with the IMSI using the 32 LSB of an HTTP Digest CHALLENGE as the Global RAND, the IMSI derived from the IMPI and IMPU, and the AUTHR received from the mobile units 105. The HSS 135 may set the SMEKEY received from the HLR/AuC 140 in the IS-41 authreq (Authentication Request Return Result) message as the HTTP Digest Password and return it to the S-CSCF 135 in the Multimedia-Auth-Answer (MAA) command on the Cx:Diameter interface. In one embodiment, the HSS 135 may compute the CK and IK from the SMEKEY and PLCM received from the HLR/AC 140, and return is to the S-CSCF 135 in the MAA command.

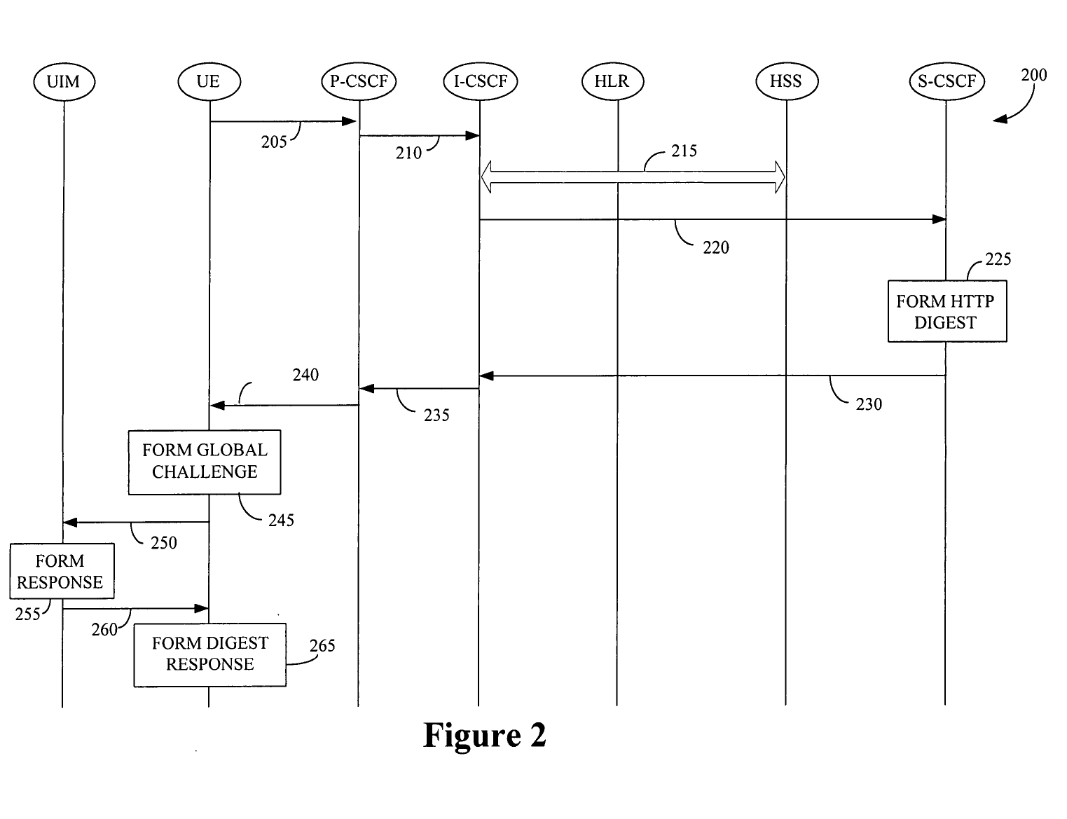

FIG. 2 conceptually illustrates a first portion 200 of one exemplary embodiment of a method of mutually authenticating a user identity module (UIM) and a first entry node. In the illustrated embodiment, the first entry node is a P-CSCF, such as the P-CSCF 120 described above. User equipment (UE) initiates the IMS service registration by providing a registration message to the P-CSCF, as indicated by arrow 205. The registration message is forwarded to an I-CSCF, as indicated by the arrow 210. The I-CSCF then accesses the HSS to request information indicating a location of the appropriate S-CSCF, and the HSS provides this information to the I-CSCF, as indicated by the double arrow 215. The I-CSCF provides the registration request to the S-CSCF, as indicated by the arrow 220.

The S-CSCF forms (at 225) an authentication challenge using the information provided by the P-CSCF. In alternative embodiments, information indicative of the IMPI and/or IMPU associated with the user identity module (UIM) may or may not be included in the message provided to the S-CSCF. If information indicative of the IMPI is not included in the received message, the S-CSCF may form (at 225) an HTTP digest using a random number, CHALLENGE. If information indicative of the IMPI is included in the received message, the S-CSCF may access authentication information stored in the HSS and then form (at 225) an HTTP digest using a random number, CHALLENGE, as well as information retrieved from the HSS. In one embodiment, the S-CSCF may also analyze the IMPI and/or IMPU included in the received message to determine whether the UIM supports the same security protocol used by the S-CSCF. For example, the S-CSCF may determine that the UIM supports CAVE-based authentication and does not support full IMS authentication. However, persons of ordinary skill in the art having benefit of the present disclosure should appreciate that the present invention is not limited to carrying out the aforementioned steps at the S-CSCF and, in alternative embodiments, one or more of the above-mentioned tasks may be performed at other locations within the wireless communication system.

The HTTP Digest Request containing the CHALLENGE value may be incorporated into one or more messages that may be provided to the UE via the I-CSCF and P-CSCF, as indicated by the arrows 230, 235, 240. The UE may then translate (at 245) the received challenge into a new challenge according to a different security protocol. For example, the UE may recover the CHALLENGE value from the HTTP Digest Request and use the 32 Least Significant Bits of CHALLENGE as a Global RAND that may be used as a challenge according to the TIA/EIA-41 security protocol. The Global RAND is sent to the UIM as a Global Challenge for Origination or Page Response, as indicated by the arrow 250. The UIM may then compute (at 255) one or more security keys based upon the challenge received from the UE. In one embodiment, the UIM computes (at 255) the digital signature AUTHR, the PLCM, and the SMEKEY. The UIM forms (at 255) a response using the computed parameters, including the security keys, and returns the response to the UE, as indicated by the arrow 260. The UE forms (at 265) a digest response based on the response received from the UIM. For example, the UE may form (at 265) an HTTP digest response using the SMEKEY, IMPI, and full HTTP Digest CHALLENGE. In one embodiment, if UE-to-P-CSCF security is required, the UE may also compute the session keys, CK=f(SMEKEY, PLCM, “CK”) and IK=f(SMEKEY, PLCM, “IK”). Here ‘f’ denotes any suitable pseudo-random function, such as HMAC, EHMAC, and the like.

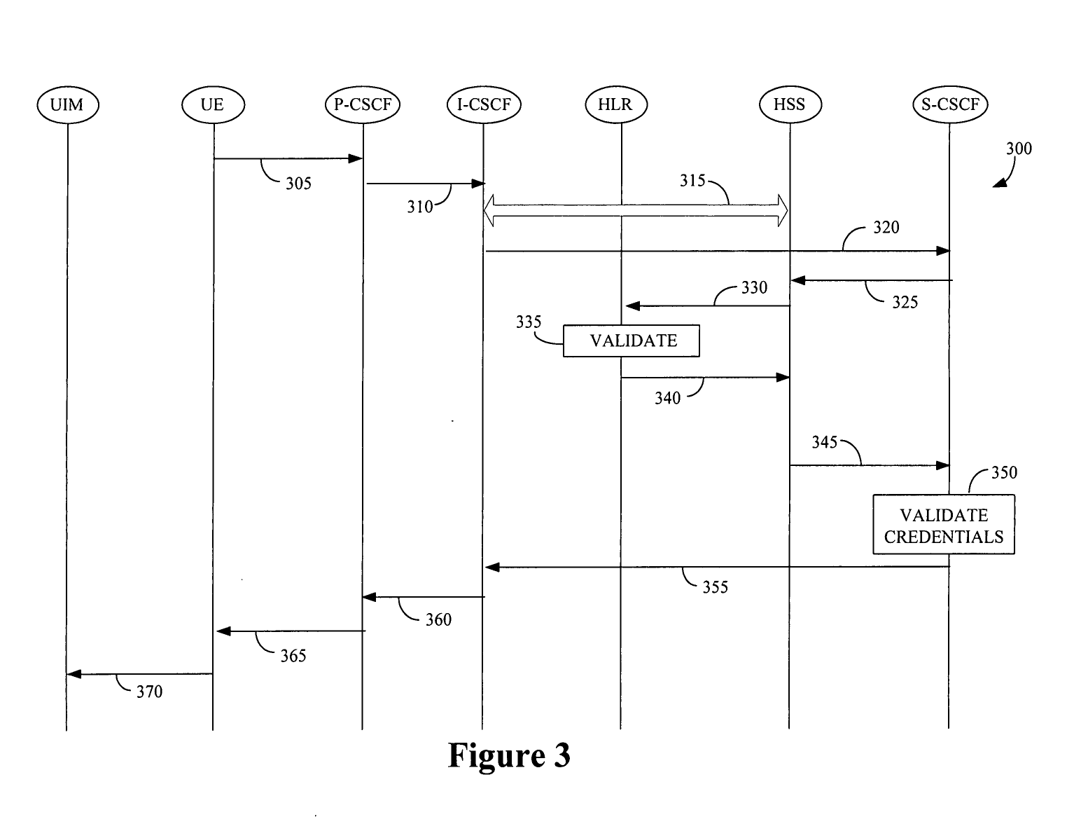

FIG. 3 conceptually illustrates a second portion 300 of one exemplary embodiment of a method of authenticating a user identity module (UIM) to a first entry node. In the illustrated embodiment, the UE provides the response that was formed (at 265 of FIG. 2) in response to the information received from the UIM to the P-CSCF, as indicated by the arrow 305. For example, the UE may provide (at 305) the HTTP digest response, as well as other information such as the RAND and the digital signature AUTHR. The P-CSCF then provides one or more messages including the information provided by the UE to the I-CSCF and on to the S-CSCF (using information provided by the HSS, as discussed above), as indicated by arrows 310, 315, 320. For example, the UE may send (at 305) an SM7 message containing the HTTP Digest RESPONSE to the P-CSCF, which forwards the information to the S-CSCF in messages SM8 and SM9 (at 310, 315, 320).

On receiving the information from the UE, the S-CSCF forms a message including authentication information, such as the authentication information provided by the UE or other information that may be formed using the authentication information provided by the UE. For example, the S-CSCF may set the value of RAND using the 32 LSB of the CHALLENGE or nonce, recover the value of the digital signature AUTHR using the cnonce, concatenate RAND with AUTHR, and populate an appropriate field in a Cx: Multimedia-Authentication-Request (MAR) message. The S-CSCF may then provide the authentication information to the HSS, as indicated by the arrow 325. For example, the S-CSCF may provide (at 325) the MAR message to the HSS. In one embodiment, the IMPI and IMPU associated with the UE are also sent in the MAR message.

The HSS uses the information provided by the S-CSCF to generate additional information that may be used to authenticate the UIM. In the illustrated embodiment, the HSS recovers the IMSI from the provided IMPI and IMPU and creates an authorization request, such as an IS-41 AUTHREQ, with the IMSI, RAND, and the digital signature AUTHR. The HSS provides the information that may be used to authenticate the UIM to the HLR/AuC, as indicated by the arrow 330. The HLR/AuC may then validate (at 335) the information provided by the HSS. For example, the HLR/AuC may validate (at 335) the digital signature AUTHR. If the HLR/AuC successfully validates (at 335) the information provided by the HSS, the HLR/AuC computes one or more session keys, such as the SMEKEY and PLCM, using the information provided by the HSS and provides the session keys to the HSS, as indicated by the arrow 340.

The HSS provides some or all of the information received from the HLR/AuC to the S-CSCF, as indicated by the arrows 345. In the illustrated embodiment, the HSS returns (at 345) one or more keys, such as the SMEKEY and PLCM, to the S-CSCF, which may use one or more of the keys as a password for the HTTP Digest. The S-CSCF may then validate (at 350) the credentials that were provided by the UE. For example, the S-CSCF may validate (at 350) the HTTP Digest RESPONSE using the SMEKEY as a digest password. If the S-CSCF successfully validates (at 350) the credentials, then the S-CSCF provides a message to the UE indicating that the authentication was successful, thereby authenticating the UIM in the wireless communication network, as indicated by the arrows 355, 360, 365, 370. For example, the S-CSCF may send the authentication message (2xx Auth_OK) to the P-CSCF in messages SM10 and SM11. The P-CSCF may then forward the Auth_OK message to the UE in SM12. In one embodiment, the S-CSCF computes one or more session keys, such as a cipher key (CK), an integrity key (IK), and the like. For example, the CK and IK may be formed using the SMEKEY and the PLCM. The session keys may also be provided to the UE with the messages 355, 360, 365.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of authenticating at least one user identity module and an entry node of a wireless communication system, comprising:
receiving, from the entry node, at least a first challenge formed according to at least a first security protocol;
forming, according to at least a second security protocol different from the first security protocol, at least a second challenge based on the first challenge; and
providing the second challenge to the user identity module.

2. The method of claim 1, wherein receiving the first challenge formed according to the first security protocol comprises receiving an HTTP digest challenge formed according to an Authentication and Key Agreement security protocol from a proxy call session control function.

3. The method of claim 1, wherein forming the second challenge based on the first challenge comprises forming the second challenge from a selected number of bits in the first challenge.

4. The method of claim 3, wherein forming the second challenge comprises forming a nonce using the 32 least significant bits of the first challenge.

5. The method of claim 1, wherein forming the second challenge comprises forming the second challenge according to a TIA/EIA-41 security protocol.

6. The method of claim 1, comprising receiving a first response from the user identity module in response to the second challenge.

7. The method of claim 6, wherein receiving the first response comprises receiving at least one of a digital signature, a signaling message key, and a public long code mask.

8. The method of claim 7, comprising forming at least one key based on at least one of the signaling message key and the private long code mask.

9. The method of claim 7, comprising forming a second response based on at least one of the first challenge, the signaling message key, a private identifier, the second challenge, and the digital signature.

10. The method of claim 9, wherein forming the second response comprises forming an HTTP digest response based on at least one of the first challenge, the signaling message key, and the private identifier.

11. The method of claim 9, comprising providing the second response to the entry node.

12. The method of claim 11, comprising receiving a third response from the entry node in response to providing the second response.

13. The method of claim 12, comprising authenticating the user identity module to the entry node based on the third response.

14. A method of authenticating a user identity module associated with at least one mobile unit, comprising:
providing at least a first challenge formed according to at least a first security protocol to the mobile unit;
receiving at least a first response formed based on at least a second response provided to the mobile unit by the user identity module, the second response being formed based on the first challenge according to a second security protocol different from the first security protocol; and
authenticating the user identity module based on the first response.

15. The method of claim 14, comprising forming the first challenge according to the first security protocol.

16. The method of claim 15, wherein forming the first challenge comprises determining whether a private identifier has been received.

17. The method of claim 16, wherein forming the first challenge comprises retrieving authentication information from a home subscription server in response to determining that the private identifier has been received.

18. The method of claim 14, wherein forming the first challenge according to the first security protocol comprises forming an HTTP digest challenge according to an HTTP Digest protocol.

19. The method of claim 14, wherein receiving the first response comprises receiving the first response formed based upon a second response that is formed by the user identity module according to a TIA/EIA-41 security protocol.

20. The method of claim 14, wherein receiving the first response comprises receiving information indicative of at least one of the first challenge, a signaling message encryption key, a private identifier, a second challenge formed based on the first challenge, and a digital signature received from the user identity module.

21. The method of claim 20, wherein receiving the first response comprises receiving an HTTP digest response formed based on at least one of the first challenge, the signaling message encryption key, and the private identifier.

22. The method of claim 14, wherein authenticating the user identity module comprises providing an authorization request to at least one of a Home Location Register and an authentication center.

23. The method of claim 22, wherein providing the authorization request comprises providing an authorization request formed using at least one of a subscriber identifier, a second challenge formed based on the first challenge, and a digital signature received from the user identity module.

24. The method of claim 22, comprising receiving an authorization request response.

25. The method of claim 24, wherein receiving the authorization request response comprises receiving an authorization request response comprising information indicative of at least one of a signaling message encryption key and a private long code mask.

26. The method of claim 25, wherein authenticating the user identity module comprises authenticating the user identity module using the signaling message encryption key.

27. The method of claim 25, comprising generating at least one key based on at least one of the signaling message encryption key and the private long code mask.

28. The method of claim 14, comprising providing a message indicating that the user identity module has been authenticated in response to authenticating the user identity module.
